(19) United States
(12) Patent Application Publication
(10) Pub. No.: US 2016/0116568 A1
(43) Pub. Date: Apr. 28, 2016

(54) POSITIONING METHOD AND DEVICE

(71) Applicant: SIEMENS AKTIENGESELLSCHAFT, München (DE)

(72) Inventors: Jörg HEUER, Oberhaching (DE); Anton SCHMITT, Vaterstetten (DE); Andreas SCHOLZ, Unterschleissheim (DE); Martin WINTER, Rosenheim (DE)

(73) Assignee: SIEMENS AKTIENGESELLSCHAFT, München (DE)

(21) Appl. No.: 14/891,243

(22) PCT Filed: Apr. 22, 2014
(86) PCT No.: PCT/EP2014/058120

§ 371 Date: Nov. 13, 2015

(30) Foreign Application Priority Data
May 17, 2013 (DE) 10 2013 209 235.0

(51) Int. Cl. G01S 5/22; G01S 5/06

(52) U.S. Cl. CPC G01S 5/22; G01S 5/06

(57) ABSTRACT

A measurement method, used when there is a fairly large distance between a vehicle and a charging station, determines a distance by way of absolute propagation time measurement. In a proximity zone between the charging station and the vehicle, a relative propagation time measurement is carried out between received signals.

### CROSS REFERENCE TO RELATED APPLICATIONS

This application is the U.S. national stage of International Application No. PCT/EP2014/058120, filed Apr. 22, 2014 and claims the benefit thereof. The International Application claims the benefit of German Application No. 102013209235.0 filed on May 17, 2013, both applications are incorporated by reference herein in their entirety.

### BACKGROUND

Described below are positioning methods and devices.

Different approaches for “electrically” refueling electrically powered vehicles are currently being discussed. For example, hybrid electric buses can be subjected to DC charging via a pantograph. In this case, the pantograph, that is to say a type of current collector, is lowered onto the electric bus from above. The pantograph has, for example, three contact points for DC+, DC− and GND (DC: direct current, GND: ground) which have to be connected to corresponding contacts on the electric bus. For this purpose, it is necessary for the bus to be maneuvered to a charging station provided for this purpose with an accurate position during positioning for the purpose of charging.

Previous solutions in the case of streetcars or trains operate using simple current collectors which only have to produce a contact with the catenary wire since these vehicles are grounded via the rail itself. Therefore, contact can be made between the catenary and current collectors in a relatively inaccurate manner in streetcars or trains.

In order to park vehicles or in the field of robotics, it is also known practice to detect obstacles on the basis of reflections of emitted ultrasonic waves and to accordingly inform a user or control electronics.

### SUMMARY

Therefore, the methods and devices described below make it possible, with the aid of ultrasound, to position a charging unit of a vehicle with respect to a charging device of a charging station in a simple manner, with a large capture range and with a high degree of accuracy.

A method for determining a position of a charging unit of a vehicle with respect to a charging device of a charging station includes:
assigning a first positioning unit to the charging device;
assigning a second positioning unit to the charging unit;
assigning a first sensor to one of the first or second positioning units;
assigning at least two second sensors to the first or second positioning unit which has not yet been assigned a first sensor;
determining a first distance and a second distance between the first sensor and one of the at least two second sensors by the following:
   a) if the first sensor is at a minimum distance from at least one of the two second sensors, by
emitting a first signal from one of the at least two second sensors to the first sensor,
emitting a second signal to one of the at least two second sensors after the first signal has been received by the first sensor, and
determining a first distance taking into account a signal propagation time of the first signal, a signal propagation time of the second signal and a propagation speed of signals in air;
   b) otherwise by
emitting a third signal by the first sensor and receiving the third signal by at least two of the at least two second sensors,
determining a respective propagation time difference between the respective reception of the third signal by two of the at least two second sensors in each case,
determining a second distance by forming a point of intersection between a first line and a second line, the respective line indicating possible whereabouts of the first sensor with respect to one of the at least two second sensors, at least the first line being formed on the basis of the propagation time difference.

Within the scope of this method, a distinction is made between a close range or near field and a far range or far field during positioning. The far range relates to the approach of the vehicle with respect to the charging station which involves rather rough positioning of the vehicle with respect to the charging station. In this case, an absolute distance is calculated by absolute propagation time determination. In the close range between the vehicle and the charging station, the positioning must be carried out in a very exact manner since the energy can flow optimally only when the first and second charging units are positioned exactly, for example during inductive charging. Therefore, a distance determination which is more complex in comparison with the far range is carried out in the close range or near field. In this case, the propagation time difference is determined when a third signal is received by at least two of the second sensors. This has the advantage that interference in the area surrounding the first and second sensors can be “averaged out” as it were, for example propagation time differences caused by snow or in the case of high humidity. An advantage of the method therefore lies in the scalability of the complexity of the computing, depending on the positioning accuracy requirement. In addition, the two-stage method makes it possible for a vehicle which is approaching the charging column to inform the charging column of approach by emitting the first signal, with the result that it is then possible to change over from the absolute measurement to the relative measurement. The changeover can be signaled to the charging column or the first sensor, for example, by a special signal. The term “capture range” can be understood as meaning the terms “close range” and “far range”. The minimum distance, for example 1 m, defines the boundary between the close range and the far range. The minimum distance can be adapted depending on the specific implementation of the application, for example if the vehicle is an automobile or a streetcar. Signal waves which can be wirelessly transmitted and also allow accurate measurements in the case of short distances between the vehicle and the charging station are understood as signals. Short distances are understood as meaning distances of several meters to a few centimeters.

The second line is advantageously formed by a propagation time difference of two of the at least two second sensors, none or only one of the second sensors being used when generating the first line. As a result of this, the positioning can also be carried out if there are no reference points for determining the position of the vehicle with respect to the charging station, for example a predefined route of the vehicle.

In an alternative development, the second line is determined on the basis of a route of the vehicle, the second line running parallel to the route and through the first sensor. As a result, it is possible to simplify the determination when determining the position of the vehicle with respect to the charging station in the close range.

In one particular embodiment, the first sensor is assigned to the first positioning unit and the at least two second sensors are assigned to the second positioning unit. As a result, the positioning can be carried out by the vehicle which can actively influence the approach to the charging station.

In one embodiment, the first, second and/or third signal is/are transmitted at different frequencies or with different signal patterns. As a result, the distance can be determined in a more exact manner since interfering influencing variables, such as reflections or echoes of the signals, can be detected and taken into account in the determination.

In an additional or alternative embodiment, to respectively arrange the first and/or at least one of the second sensors, a signal-shaping screen is respectively used at a respective first or second opening angle for emitting and receiving the respective signal. As a result, both signal interference can be reduced further and manipulation attempts by third parties can be reduced or avoided.

The first sensor and the at least two second sensors advantageously operate with ultrasonic or radar waves. This has the advantage that sensors already present in the vehicle can be used for positioning, thus making it possible both to considerably simplify an implementation of the device in terms of technology and costs and to considerably increase acceptance by the market.

Also described below is a device for determining a position of a charging unit of a vehicle with respect to a charging device of a charging station, having
a first positioning unit of the charging device,
a second positioning unit of the charging unit,
a first sensor assigned to one of the first or second positioning units,
at least two second sensors assigned to the first or second positioning unit which has not yet been assigned a first sensor, and
a determination unit for determining a first distance and a second distance between the first sensor and one of the at least two second sensors by,
   a) if the first sensor is at a minimum distance from at least one of the two second sensors,
emitting a first signal from one of the at least two second sensors to the first sensor,
emitting a second signal to one of the at least two second sensors after the first signal has been received by the first sensor, and
determining a first distance taking into account a signal propagation time of the first signal, a signal propagation time of the second signal and a propagation speed of signals in air;
   b) otherwise by
emitting a third signal by the first sensor and receiving the third signal by at least two of the at least two second sensors,
determining a respective propagation time difference between the respective reception of the third signal by two of the at least two second sensors in each case,
determining a second distance by forming a point of intersection between a first line and a second line, the respective line indicating possible whereabouts of the first sensor with respect to one of the at least two second sensors, at least the first line being formed on the basis of the propagation time difference.

The device shows the same advantages as the corresponding method.

In one development, the device has a further unit which is configured in such a manner that at least part of the method can be implemented and executed. The device shows the same advantages as the corresponding method.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram illustrating approach maneuvers of a vehicle having a charging unit in the direction of a charging device of a charging station;

FIG. 2 is a schematic diagram illustrating determination of a first distance in a far range of the vehicle with respect to the charging station;

FIG. 3 is a schematic diagram illustrating determination of a position between the charging unit and the charging device in the near field of the vehicle with respect to the charging station;

FIG. 4 is a flowchart illustrating the method;

FIGS. 5A and 5B are schematic diagrams illustrating respective opening angles of the first ultrasonic sensor and at least one of the second ultrasonic sensors.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Elements having the same function and method of operation are provided with the same reference symbols in the present application.

The embodiments are shown using ultrasonic sensors for sensors and ultrasonic signals for signals.

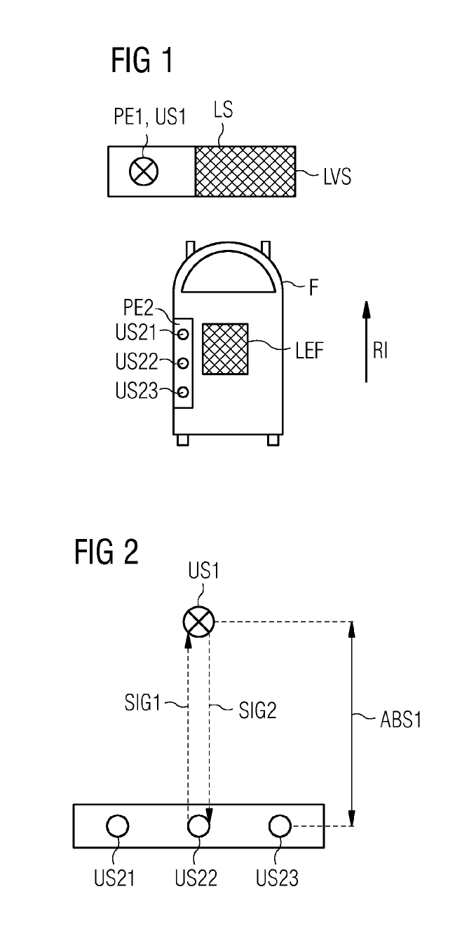

FIG. 1 shows a typical approach situation of a vehicle F, for example a bus, in the direction RI of a charging station LS. The vehicle has, inter alia, a charging unit LEF, for example in the form of a current collector or a plurality of contact points on the roof of the bus. FIG. 1 also shows a second positioning unit PE2 having three ultrasonic sensors US21, US22, US23 on the roof of the bus. When assigning the second positioning unit to the charging unit, a local orientation of the charging unit with respect to the arrangement of the second positioning unit or with respect to the arrangement of the respective second sensors is known. In the present exemplary embodiment, the three second ultrasonic sensors are fitted in a row with a distance of 50 cm on the roof of the bus. In FIG. 1, the charging unit is accommodated in a field of 50×50 cm which is arranged parallel to the second positioning unit PE2 at a distance of 30 cm.

The charging station LS has a first positioning unit PE1 having a first ultrasonic sensor US1. The charging station also has the charging device LVS which is configured, for example, from tensioned catenaries which, after the vehicle has made contact with the current collector, can transmit electrical energy into the battery of the vehicle via the charging device of the charging station and via the charging unit of the vehicle. In an alternative embodiment, the charging device is provided with a plurality of extendable contact points for each pantograph which are extended after a position of the vehicle beneath the charging station has been reached and are contact-connected to the charging points of the charging unit and are configured to transmit electrical energy after contact has been made.

In order to be able to ensure correct charging of the battery of the vehicle by the charging station, the charging unit and the charging device must be positioned exactly with respect to one another. For this purpose, it is necessary to repeatedly determine the position with respect to one another while the vehicle approaches the charging station in order to be able to achieve the correct positioning.

For this purpose, two different methods are used depending on the distance between the vehicle and the charging station. If the vehicle is in the far field of the charging station, for example greater than 1 m, an absolute measurement of the distance between the first ultrasonic sensor US1 and at least one of the second two ultrasonic sensors US22 is first of all carried out. As can be gathered from FIG. 2, the second ultrasonic sensor US22 emits a first ultrasonic signal SIG1 for this purpose, which signal is then received by the first ultrasonic sensor US1. The first ultrasonic sensor US1 responds to this with a second ultrasonic signal SIG2 which is then received by the second ultrasonic sensor US22. The second ultrasonic sensor US22 knows the time at which the first ultrasonic signal was transmitted and the second ultrasonic signal was received, that is to say the propagation time DT of the first and second ultrasonic signals. This propagation time is 100 ms, for example. A first distance ABS1 between the second ultrasonic sensor US22 and the first ultrasonic sensor US1 can be calculated therefrom as follows using the following formula:

ABS1=DT/2*Va,

where Va describes the propagation speed of ultrasonic signals in air, Va=343 m/s.

In this example, the first distance is ABS1=0.1 s/2*343 m/s=17.15 m.

The absolute measurement of the first distance between the first and second ultrasonic sensors is carried out in a simplified form since it involves a first rough determination of the distance between the vehicle and the charging station. The determination of the first distance can be improved by virtue of the fact that a speed of the vehicle during the measurement and also an acceleration or deceleration of the vehicle during the measurement can be taken into account.

In another embodiment, the first ultrasonic sensor US1 delays the emission of the second ultrasonic signal SIG2 by VT. This makes it possible to distinguish between the second ultrasonic signal SIG2 and an echo of the first ultrasonic signal SIG1 from surrounding objects. If VT=500 ms is selected, for example, echoes of the first ultrasonic signal can no longer be expected on account of the attenuation of the first ultrasonic signal. In this embodiment, the first distance ABS1 can be calculated as follows:

ABS1=(DT−VT)/2*Va.

In another embodiment, the measurement can be accelerated and a distinction can nevertheless be made between the echo of the first ultrasonic signal and the second ultrasonic signal by virtue of the first ultrasonic sensor using a frequency for the second ultrasonic signal which differs from a frequency of the first ultrasonic signal and is sufficiently far away from the frequency of the first ultrasonic signal, with the result that it also cannot be produced from the first ultrasonic signal by the Doppler shift during a movement of the vehicle. Alternatively, the first and second ultrasonic signals can use the same frequencies but with different amplitudes and/or signal waveforms. A square-wave signal is therefore modulated onto the first ultrasonic signal, whereas the second ultrasonic signal has a triangular signal.

In a further embodiment, different matching filter pairs which are as orthogonal as possible are used for the first and second ultrasonic signals for the purpose of modulating and detecting the first and second ultrasonic signals. The use of matching filter pairs is known to a person skilled in the art from the literature.

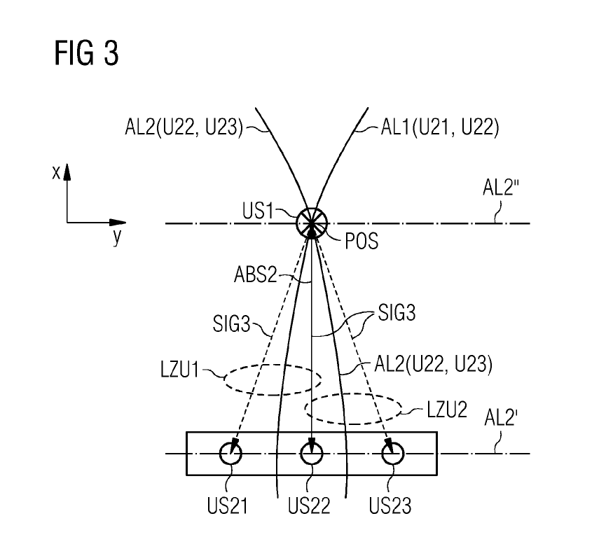

If the vehicle leaves the far range and is in a close range with respect to the charging station, for example between 0 m and 1 m, a second distance is determined. A determination of a second distance between the first ultrasonic sensor and at least one of the second ultrasonic sensors is explained in more detail below with the aid of FIG. 3. For this purpose, the first ultrasonic sensor emits a third ultrasonic signal SIG3 which is received by two of the second ultrasonic sensors US21, US22. If it is shown that the signal propagation times for receiving the third ultrasonic signal SIG3 by the two second ultrasonic sensors are identical, that is to say a first propagation time difference LZU1 is 0, the first ultrasonic sensor US1 is equidistant from the two second ultrasonic sensors. In this case, the location of the first ultrasonic sensor can be found on a first line AD which corresponds to a straight line given a signal propagation time difference of 0. In this case, the first line runs through the first ultrasonic sensor and runs centrally between the two second ultrasonic sensors.

However, on account of this relative measurement, the explicit location is not known, but rather only the first line on which the first ultrasonic sensor lies at some point. In order to accurately determine the position of the first ultrasonic sensor with respect to the second ultrasonic sensors, a second line AL2 is needed, the first ultrasonic sensor with respect to the second ultrasonic sensors lying at a point of intersection between the first and second lines. There are two variants for forming the second line:

In a first variant, the vehicle moves on a predefined route in the direction of the charging station. The second line AL2 can be formed by virtue of the fact that it runs parallel to the route of the vehicle and through the first ultrasonic sensor, that is to say parallel to the route. For example, there is a predefined line on the road to the charging station, which line is followed by the vehicle to the charging station. Therefore, the second line AL2 is already defined when the vehicle approaches the charging station. This is marked in FIG. 3 using a line AL2″ which runs parallel to the route AL2′ of the vehicle. The location at which the first ultrasonic sensor US1 is positioned is found at the point of intersection between the first and second lines. This can be used to calculate the position of the first ultrasonic sensor with respect to the second ultrasonic sensors. For example, a Cartesian coordinate system xy is spanned in which the second distance can be determined from x and y components.

In a second variant, the first propagation time difference LZU1 for receiving the third ultrasonic signal at the second ultrasonic sensors US21, US22 and a second propagation time difference LZU2 for the second ultrasonic sensors US22, US23 are determined. As explained in the previous example, the first and second propagation time differences produce the first and second lines AL1, AL2 which each have an elliptical shape in the case of propagation time differences which are not equal to 0. The location of the first sensor US1 lies at the point of intersection between the lines.

As illustrated in FIG. 3, there may be two points of intersection, for example, in the second variant. By aligning the second ultrasonic sensors in the direction of the first ultrasonic sensor, the first ultrasonic sensor may only be in the region from which the third ultrasonic signal SIG3 is received. It is therefore possible to unambiguously determine the point of intersection.

In order to increase the measurement accuracy, the first, second and/or third ultrasonic signal may be transmitted at different frequencies or with different signal patterns. In addition, ultrasonic signals which are transmitted with a time delay, for example when transmitting the third ultrasonic signal, can also be generated at intervals of time of 20 s, for example, with different frequencies and/or different signal patterns in order to avoid or reduce incorrect measurements.

The examples presented relate to a configuration in which the first ultrasonic sensor has been assigned to the first positioning unit and a plurality of second ultrasonic sensors have been assigned to the second positioning unit. The device may likewise be implemented if the second ultrasonic sensors are assigned to the first positioning unit and the first ultrasonic sensor is assigned to the second positioning unit. Moreover, the positioning in the far range can be improved by superimposing two or more measurements. Furthermore, it is also possible to use more than three second ultrasonic sensors, thus making it possible to increase a measurement accuracy.

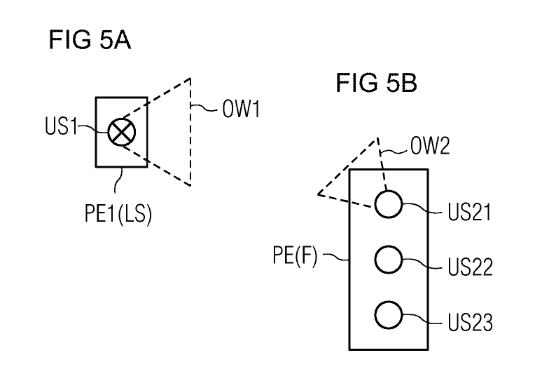

In another embodiment, in order to respectively arrange the first and second ultrasonic sensors, a respective first or second opening angle OW1, OW2 is introduced for emitting and receiving the ultrasonic signal. For this purpose, as illustrated in FIGS. 5A and 5B, the respective opening angles of the first ultrasonic sensor and of at least one of the second ultrasonic sensors are aligned with the position unit PE1 of the charging station LS to be approached for the measurement in the far field in the direction of the position unit PE2 of the approaching vehicle F. The respective opening angles can be set using a respective screen in front of the respective ultrasonic sensor.

In another embodiment, the opening angles of the first ultrasonic sensor and of at least one of the second ultrasonic sensors for the measurement in the far field are aligned in such a manner that these ultrasonic sensors, as illustrated in FIG. 5, can transmit ultrasonic signals to one another both in the far field and in the near field.

In another embodiment, at least three ultrasonic sensors are respectively used both in the positioning unit PE1 and in the positioning unit PE2. In this embodiment, the position calculation is carried out in both positioning units and is interchanged by communication and is mutually checked.

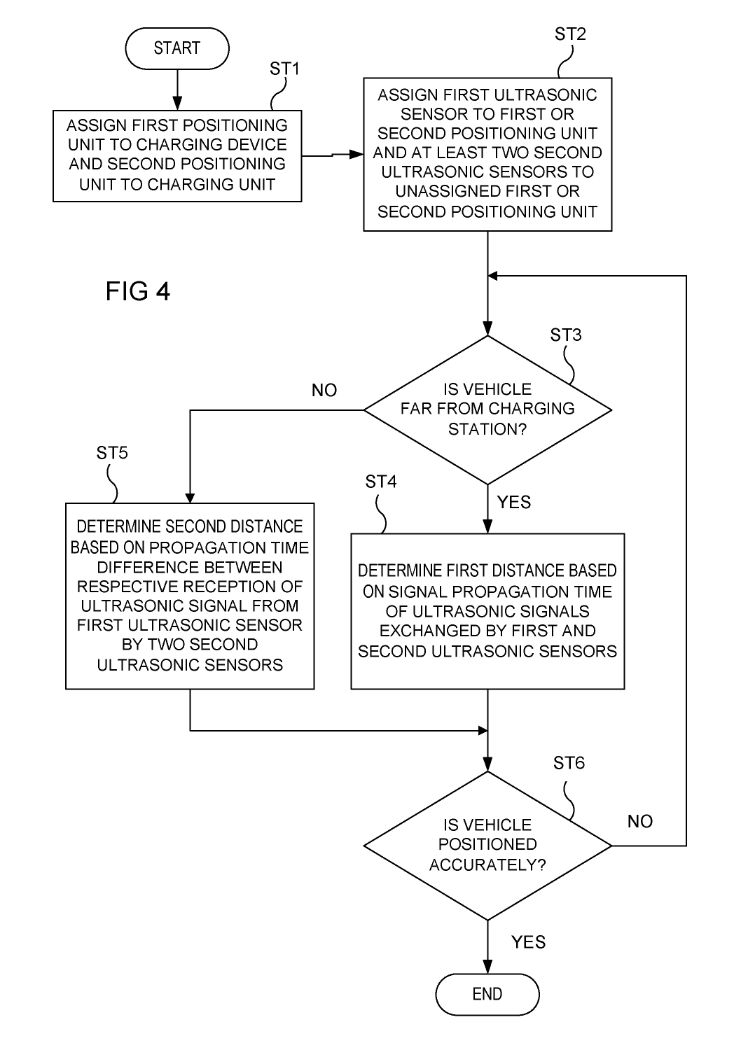

FIG. 4 shows a flowchart of the method. The latter starts in the state STA.

In ST1, the first positioning unit is assigned to the charging device and the second positioning unit is assigned to the charging unit.

In ST2, the first ultrasonic sensor is then assigned to one of the first or second positioning units and at least two second ultrasonic sensors are assigned to the first or second positioning unit which has not yet been assigned a first ultrasonic sensor.

In ST3, a determination is made as to whether the vehicle is in the near field or far field with respect to the charging station.

If the vehicle is in the far field, the first distance is determined in ST4 in such a manner that the first ultrasonic signal is first of all emitted to the first ultrasonic sensor by one of the at least two second ultrasonic sensors, the second ultrasonic signal is furthermore transmitted back to one of the at least two second ultrasonic sensors after the first ultrasonic signal has been received by the first ultrasonic sensor, and the first distance is determined taking into account a signal propagation time of the first and second ultrasonic signals and a propagation speed of ultrasonic signals in air.

In ST6, a determination is made as to whether the first distance indicates that the charging unit of the vehicle has already been positioned with sufficient accuracy with respect to the charging device of the charging station for a charging operation. If this is the case, the state diagram is ended at END.

If the first distance indicates that the charging unit of the vehicle has not been positioned with sufficient accuracy, the state diagram returns to ST3. If the vehicle is in the near field of the charging station, operations in ST5 are performed instead of those in ST4. In ST5, a third ultrasonic signal is first of all emitted by the first ultrasonic sensor and is received by at least two of the at least two second ultrasonic sensors, a respective propagation time difference between the respective reception of the third ultrasonic signal by two of the at least two second ultrasonic sensors in each case is determined, and the second distance ABS2 is determined by forming a point of intersection between a first line and a second line, the respective line indicating possible whereabouts of the first ultrasonic sensor with respect to one of the at least two second ultrasonic sensors, at least the first line being formed on the basis of the propagation time difference.

If ST5 reveals that the second distance, that is to say a distance between the charging station and the charging unit, has been positioned with sufficient accuracy for carrying out a charging operation, the state diagram is ended in the state END. Otherwise, the state diagram is continued in ST3.

In another variant, information for authorization is impressed on the respective ultrasonic signals, for example by amplitude, phase and/or frequency modulation. This makes it possible to avoid manipulation attempts or disruptions by undesirable third parties.

The invention was explained in more detail using ultrasonic waves and sensors, but is not restricted to this type of wireless waves. Rather, it is possible to use any type of waves which enable communication from a few centimeters to several meters, for example radar waves. The latter are emitted and received with the aid of radar sensors.

In addition to charging with a pantograph, the method can additionally also be used for inductive charging of vehicles, in which case a coil of the charging station is used to position the vehicle having a receiving coil.

In another embodiment, the absolute propagation time measurement and the measurement of the propagation time difference can be combined in the near field, with the result that it is also possible to determine errors on the basis of signal propagation time delays, for example on account of snow.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for determining a position of a charging unit of a vehicle with respect to a charging device of a charging station, comprising:
assigning a first positioning unit to the charging device;
assigning a second positioning unit to the charging unit;
assigning a first sensor to a first one of the first and second positioning units;
assigning at least two second sensors to a second one of the first and second positioning units not assigned the first sensor;
determining first and second distances between the first sensor and one of the at least two second sensors
when the first sensor is more than a minimum distance from at least one of the two second sensors, by
emitting a first signal from one of the at least two second sensors to the first sensor,
emitting a second signal to one of the at least two second sensors after the first signal has been received by the first sensor, and
determining a first distance taking into account a signal propagation time of the first signal, a signal propagation time of the second signal and a propagation speed of signals in air, and
when the first sensor is not more than a minimum distance from at least one of the two second sensors, by
emitting a third signal by the first sensor and receiving the third signal by at least two of the at least two second sensors,
determining a propagation time difference between reception of the third signal by two of the at least two second sensors, respectively,
determining a second distance by forming a point of intersection between first and second lines indicating possible whereabouts of the first sensor with respect to a respective one of the at least two second sensors, at least the first line being formed based on the propagation time difference.

11. The method as claimed in claim 10, wherein the second line is based on the propagation time difference of two of the at least two second sensors and no more than one of the second sensors being used when generating the first line.

12. The method as claimed in claim 10, wherein the second line is determined based on a route of the vehicle, the second line running parallel to the route and through the first sensor.

13. The method as claimed in claim 10, wherein the first sensor is assigned to the first positioning unit and the at least two second sensors are assigned to the second positioning unit.

14. The method as claimed in claim 10, wherein the first, second and third signals are transmitted using at least one of different frequencies and different signal patterns.

15. The method as claimed in claim 10, further comprising positioning a respective signal-shaping screen to set an opening angle for emitting and receiving sensing signals by a respective sensor.

16. The method as claimed in claim 10, wherein the first sensor and the at least two second sensors operate with one of ultrasonic waves and radar waves.

17. A device for determining a position of a charging unit of a vehicle with respect to a charging device of a charging station, comprising:
a first positioning unit of the charging device;
a second positioning unit of the charging unit;
a first sensor assigned to a first one of the first and second positioning units;
at least two second sensors assigned to a second one of the first and second positioning units not assigned the first sensor; and
a processor programmed to determine first and second distances between the first sensor and one of the at least two second sensors
when the first sensor is more than a minimum distance from at least one of the two second sensors, by
emitting a first signal from one of the at least two second sensors to the first sensor,
emitting a second signal to one of the at least two second sensors after the first signal has been received by the first sensor, and
determining a first distance taking into account a signal propagation time of the first signal, a signal propagation time of the second signal and a propagation speed of signals in air, and
when the first sensor is not more than a minimum distance from at least one of the two second sensors, by
emitting a third signal by the first sensor and receiving the third signal by at least two of the at least two second sensors,
determining a propagation time difference between reception of the third signal by two of the at least two second sensors, respectively,
determining a second distance by forming a point of intersection between first and second lines indicating possible whereabouts of the first sensor with respect to a respective one of the at least two second sensors, at least the first line being formed based on the propagation time difference.

18. The device as claimed in claim 17, wherein the second line is based on the propagation time difference of two of the at least two second sensors and no more than one of the second sensors being used when generating the first line.

19. The device as claimed in claim 17, wherein said processor determines the second line is based on a route of the vehicle, the second line running parallel to the route and through the first sensor.

20. The device as claimed in claim 17, wherein the first sensor is assigned to the first positioning unit and the at least two second sensors are assigned to the second positioning unit.

21. The device as claimed in claim 17, wherein the first, second and third signals are transmitted using at least one of different frequencies and different signal patterns.

22. The device as claimed in claim 17, further comprising a respective signal-shaping screen positioned to set an opening angle for emitting and receiving sensing signals by a respective sensor.

23. The device as claimed in claim 17, wherein the first sensor and the at least two second sensors operate with one of ultrasonic waves and radar waves.
